(19) United States
(12) Patent Application Publication
(10) Pub. No.: US 2017/0289990 A1
(43) Pub. Date: Oct. 5, 2017

(54) INCREASING PROBABILITY OF MULTICAST TRANSMISSIONS IN WLAN

(71) Applicant: MERU NETWORKS, Sunnyvale, CA (US)

(72) Inventor: Anil Kaushik, Bangalore (IN)

(21) Appl. No.: 15/088,066

(22) Filed: Mar. 31, 2016

(51) Int. Cl. H04W 72/04; H04L 5/00; H04L 12/26

(52) U.S. Cl. CPC H04W 72/048; H04L 43/16; H04L 5/0055; H04W 84/12

(57) ABSTRACT

A network device detects a multicast video stream being from an upstream resource being sent to downstream multicast members. If the number of multicast members are below a threshold (e.g., 5 stations), multicast network packets can be converted to unicast network packets. On the other hand, if the number of multicast members are above the threshold, the multicast members are divided into groupings based on capabilities of the multicast members, such as data rate capability. Data rates of transmissions are set according to the group data rate capabilities. As a result, the higher data rate members are able to operate at a higher speed rather than at the lowest common denominator. Further, because there are several multicast streams being sent, packets missed from the higher data rate stream can be picked up on the lower data rate stream.

### FIELD OF THE INVENTION

The invention relates generally to Wi-Fi computer networking, and more specifically, to increasing delivery probability of multicast video transmissions.

### BACKGROUND

Reliability in multicast video streaming is very challenging since there is not error detection. In more detail, network packets are transmitted once and assumed to reach all multicast members (or stations). There is no acknowledgment mechanism, or ACK network packet, for the transmitter to confirm whether or not transmitted network packets reached all of the members. Missing network packets in a video stream ultimately result in degraded video quality.

One solution to increase reliability is the conversion of multicast network packets to unicast network packets for each of the multicast members. In this case, ACK network packets are returned to the network device originating the unicast. However, the solution does not scale up for large memberships because the ACK protocol eventually slows down the converting network device and causes video delay.

One problem with multicasting video to a group of multicast members it that a network device typically slows down the multicast data rate to match a slowest device. As a result, devices with higher capabilities may be forced to the same lower video quality as the slower devices.

What is needed is a robust technique for converting multicast network packets to unicast network packets while minimizing degraded video quality and video delay. The solution should provide selective redundancy in multicast transmissions based on capabilities of the members and characteristics of a video stream within network packets.

### SUMMARY

The above-mentioned shortcomings are addressed by a network device that selectively adds redundancy to multicast video streams based on the characteristics of multicast members.

In one embodiment, a network device detects a multicast video stream being from an upstream resource being sent to downstream multicast members. If the number of multicast members are below a threshold (e.g., 5 stations), multicast network packets can be converted to unicast network packets. On the other hand, if the number of multicast members are above the threshold, the multicast members are divided into groupings based on capabilities of the multicast members, such as data rate capability. Data rates of transmissions are set according to the group data rate capabilities. As a result, the higher data rate members are able to operate at a higher speed rather than at the lowest common denominator. Further, because there are several multicast streams being sent, packets missed from the higher data rate stream can be picked up on the lower data rate stream.

In another embodiment, selected network packets can be automatically retransmitted. For example, I and P frames in MPEG, when dropped, cause relatively greater quality loss than other types of packets. Accordingly, the network device may automatically duplicate transmissions of network packets related to these frames. In still another alternative, more important network packets can be sent over a unicast channel.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a block diagram illustrating a multicast video streaming system for increasing probability of multicast video transmissions, according to an embodiment.

FIG. 2 is a more detailed block diagram illustrating a network device of FIG. 1, according to an embodiment.

FIG. 3 is a flow chart illustrating a method for selectively adding redundancy to multicast video streaming, according to an embodiment.

FIG. 4 a more detailed flow chart illustrating the step of determining the transmission mode for high quality video based on the number of stations receiving the multicast video of FIG. 3, according to an embodiment.

FIG. 5 is a block diagram illustrating an exemplary computing device, according to one embodiment.

### DETAILED DESCRIPTION

Multicast video streaming systems, computer-implemented methods, and (non-transitory) computer-readable mediums for selectively adding redundancy to multicast video, are described. This hybrid approach relies upon unicast video for guaranteed delivery in a first mode, until triggered to a second mode in which streams are sent at different data rates. The following disclosure relies upon the non-limiting example of video multicast streaming, although one of ordinary skill in the art will recognize how to apply the principles taught herein to non-video multicasting, to multicast alternatives, and to wireless channels other than Wi-Fi.

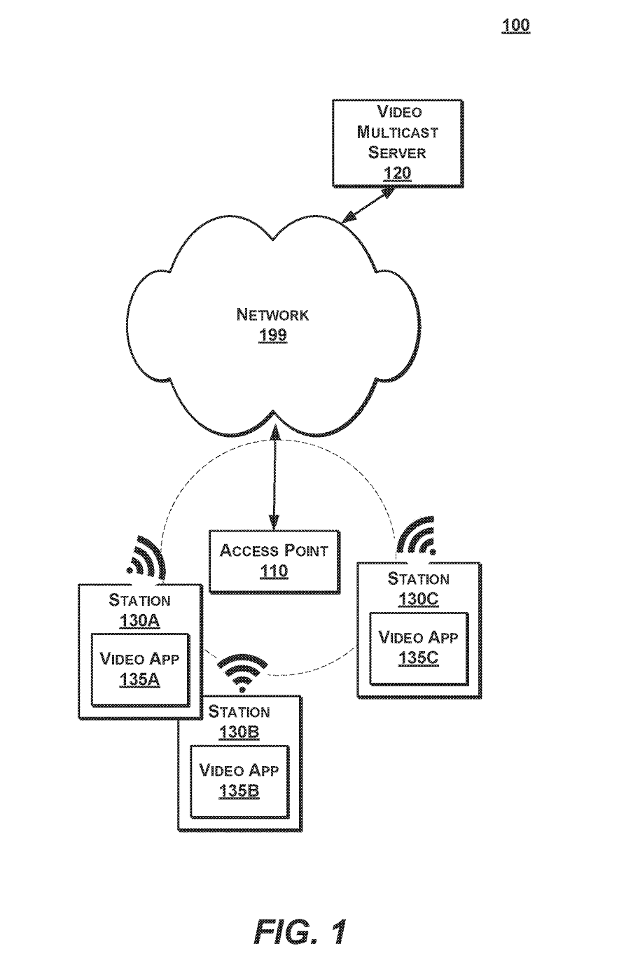

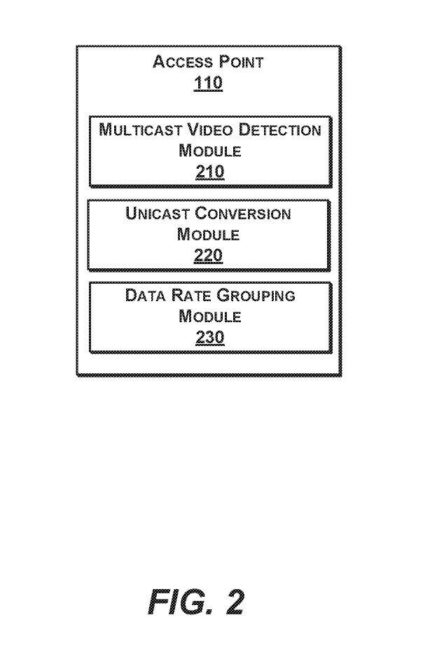

Multicast Video Streaming Systems (FIGS. 1-2)

FIG. 1 is a block diagram illustrating a multicast video streaming system 100 for selectively adding redundancy to multicast video streaming, according to an embodiment. The system 100 comprises an access point 110, a remote video server 120, and stations 130, each coupled to a network 199. Additional network components can also be part of the system 100, such as firewalls, virus scanners, routers, switches, application servers, databases, as well as additional controllers, access points, access switches, stations, SDN (Software-Defined Networking) controllers, Wi-Fi controllers, and the like. For instance, embodiments of the system 100 can be implemented in conjunction with a network security system, for example, the FortiGate Network Security platform by Fortinet of Sunnyvale, Calif. The network components can be implemented as hardware, software, or a combination of both.

The access point 110 handles multicast video streaming responsive to, for example, a number of multicast members being below a threshold, and data rate capabilities of multicast members. In a first example, a number of multicast members is below a threshold, and in response, a multicast transmission is converted to a plurality of unicast transmissions. In a second example, a number of multicast members is above a threshold, and in response, a multicast transmission is sent by distinct data rates as determined by characteristics of the multicast members. By doing so, faster devices are able to receive higher data rate transmissions than slower data rate devices. Furthermore, when faster devices miss frames at a higher data rate, those same frames can be recovered from the lower data rate transmission.

In another embodiment, selected network packets can be automatically retransmitted. For example, I and P frames in MPEG, when dropped, cause relatively greater quality loss than other types of packets. Accordingly, the access point 110 may automatically duplicate transmissions of network packets related to these frames. In still another alternative, more important network packets can be sent over a unicast channel.

In other operations, the access point 110 can perform standard operations such as BSSID (Blind Service Set Identifier) advertisement beacons. When the multicast member responds to the beacon, as indicated by returning the BSSID, a connection request initiates a Wi-Fi connection between the access point 110 and any of the multicast members 130 (or other stations not receiving multicast video streaming). Moreover, a group of access points can hand-off stations from one to another responsive to movement by mobile devices. In some network architectures, a controller manages the multiple access points from a network-wide perspective. The controller can also manage group memberships by grouping stations of similar data rates to a common access point.

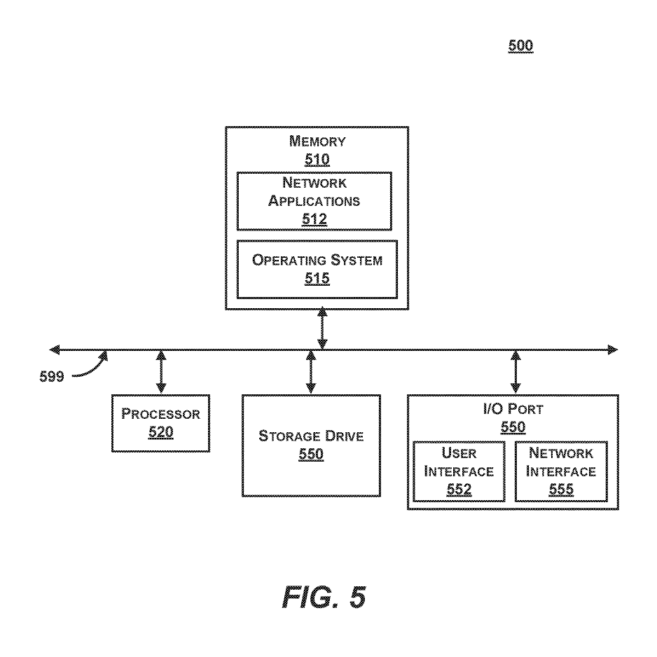

Physically, the access point 110 include one or more individual access points implemented in any of the computing devices discussed herein (e.g., see FIG. 5). For example, the access point 110 can be an AP 110 or AP 433 (modified as discussed herein) by Meru Networks of Sunnyvale, Calif. A network administrator can strategically place the access point 110 for optimal coverage area over a locale. The access point 110 can, in turn, be connected to a wired hub, switch or router connected to the enterprise network (or an external network). In embodiment, access point functionality is incorporated into a switch or router. In another embodiment, the access point 110 is a virtual device. The access point 110 is set forth in more detail below with respect to FIG. 2.

In other embodiments, the techniques described herein are implemented in a network device, which could be an access point. However, the network device can also be a controller, a router, a gateway, a server, or any other processor-driven device configured as described herein.

The remote video server 120 can be an online repository for services such as YouTube, Google Videos, or Netflix, or can be an online conference server, for example.

The stations 130 can be user devices such as a smart phone, a personal computer, a network-enabled television or other appliance, tablet devices, and the like. Any processor-driven device capable of receiving multicast video streaming can also be a station.

Wireless components preferably use communication protocols such as IEEE 802.11 n and IEEE 802.11 ac wave 2, in addition to other protocols such as other IEEE 802.11s, IEEE 802.3, Bluetooth, 3G and 4G. The network can serve, for example, a business enterprise, a hospital or system of hospital, school, building, a private network, or the like. The enterprise network can provide access to a wide area network or the Internet in some embodiments. Alternatively, the network can be distributed over the Internet, in other embodiments. A combination of wired and wireless devices can be connected, as well as only wireless devices or only wired devices. The network can be, for example, the Internet, a cellular network, a larger wide area network to which the enterprise network is a smaller component of, or a combination of network types.

FIG. 2 is a more detailed block diagram of the access point 110 of FIG. 1, according to an embodiment. The access point 110 comprises a multicast video detection module 210, a unicast conversion module 220, a data rate grouping module 230, and a transmission module 240. Many other configurations are possible. Other modules and electronics can be included, such as those components shown in FIG. 5. The components can be implemented in hardware, software, or a combination of both.

The multicast video detection module 210 detects a video stream within a multicast transmission of network packets to multicast embers, in an embodiment. For example, a packet sniffer can identify certain video formats used for multicasting, certain protocols used for video multicast, or can identify other metadata in the packets which indicates video. In one embodiment, the video multicast detection module 210 is communicatively coupled to a processor.

The unicast conversion module 220, responsive to a number of multicast members being below a threshold, converting a multicast transmission to a plurality of unicast transmissions. In one embodiment, the unicast conversion module 220 is communicatively coupled to a processor and the multicast video detection module 210.

The data rate grouping module 230 determines data rate capabilities for each of the multicast members. Then multicast members can be grouped into two or more groups based on corresponding data rate capabilities. Each group receives a multicast stream at a distinct data rate for an individual group. Some groups may have just one or a few members while other groups have hundreds or thousands of members. In one embodiment, the data rate grouping module 230 is communicatively coupled to a processor and the unicast conversion module 220.

The transmission module 240 sends two or more multicast transmissions downstream to the multicast member groups at the distinct data rates.

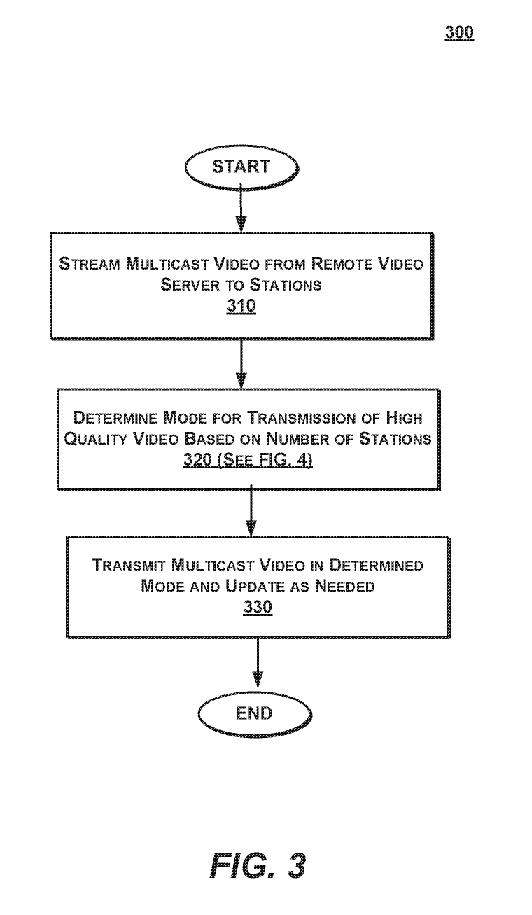

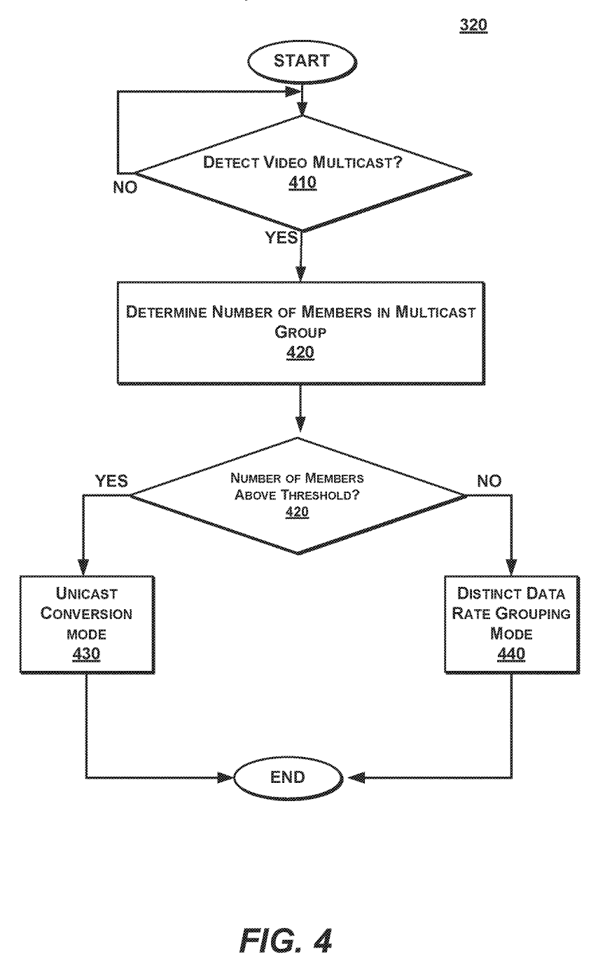

Methods for Multicast Video Streaming (FIGS. 3-4)

FIG. 3 is a flow chart illustrating a method 300 for reliable VOIP hand-offs from cellular networks to Wi-Fi networks, according to an embodiment. The process at a high-level is implementable by computer hardware, wherein individual components can perform individual steps of a method.

In method 300, a user is watching a video multicast from a remote video server to stations (step 310). A mode for transmission of high quality video is determined based on a number of stations receiving the multicast video (step 320), an example of which is set forth below with respect to FIG. 4. Multicast video is transmitted using determined mode which can be updated as needed (e.g., as number of stations changes) (step 330).

One of ordinary skill in the art will recognize that the method 300 (and others) is non-limiting as other embodiments can have more or less steps and can be performed in a different order. The method 300 can be implemented in the system 100 of FIG. 1 or in other components.

FIG. 4 a more detailed flow chart illustrating the step 320 of determining the transmission mode for high quality video based on the number of stations receiving the multicast video of FIG. 3, according to an embodiment. At a certain threshold number of user devices joining the video multicast, service quality is maintained by switching from unicast conversion mode to multicast member grouping mode.

A video stream is detected within a multicast transmission of network packets to multicast members (step 410). Responsive to a number of multicast members being below a threshold (step 420), the multicast transmission is converted to a plurality of unicast transmissions (step 430). The unicast transmissions provide guaranteed service with acknowledgments. Responsive to the number of multicast members being at or above the threshold (step 420), multicast member groups are sent transmissions at a distinct data rate (step 440). Each grouping is made by data rate capabilities, and the distinct data rates can correspond to the data rate capabilities. Data rates for groups without members can be ignored during transmission, thereby saving power and reducing network congestion.

In some embodiments, the transmissions can switch if the number of multicast members crosses a threshold. In other embodiment, the threshold is automatically determined by an amount of processing resources necessary for a network device to maintain unicast conversions. In other words, processor loads, memory storage and packet latency can become strained with too many unicast conversions for a multicast stream.

Generic Computing Device (FIG. 5)

FIG. 5 is a block diagram illustrating an exemplary computing device 500 for use in the system 100 of FIG. 1, according to one embodiment. The computing device 500 is an exemplary device that is implementable for each of the components of the system 100, including the network hand-off controller 105, the access points 132, and the station 110. The computing device 500 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 500, of the present embodiment, includes a memory 510, a processor 520, a storage drive 530, and an I/O port 540. Each of the components is coupled for electronic communication via a bus 599. Communication can be digital and/or analog, and use any suitable protocol.

The memory 510 further comprises network applications 512 and an operating system 514. The network applications 512 can include the modules of the network hand-off controller 105, the call controller 121, the Wi-Fi controller 122, the cell tower 151 and the access point 152. Other network applications 512 can include a web browser, a mobile application, an application that uses networking, a remote application executing locally, a network protocol application, a network management application, a network routing application, or the like.

The operating system 514 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 5 or Windows 8), Linux, HP-UX, UNIX, Sun OS, Solaris, Mac OS X, Alpha OS, AIX, IRIX52, or IRIX64. Other operating systems may be used. Microsoft Windows is a trademark of Microsoft Corporation.

The processor 520 can be a network processor (e.g., optimized for IEEE 802.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in the memory 510 or the storage drive 550

The storage drive 530 can be any non-volatile type of storage such as a magnetic disc, EEPROM, Flash, or the like. The storage drive 550 stores code and data for applications.

The I/O port 540 further comprises a user interface 542 and a network interface 544. The user interface 542 can output to a display device and receive input from, for example, a keyboard. The network interface 544 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method in a network device of a data communication network, for increasing delivery probability of multicast video transmissions, the method comprising the steps of:
detecting, by a processor of the network device, a video stream within a multicast transmission of network packets to multicast members;
responsive to a number of multicast members being below a threshold, converting, by the processor, the multicast transmission to a plurality of unicast transmissions, wherein the unicast transmission provides an acknowledgment for received network packets from the multicast members;
responsive to the number of multicast members meeting or exceeding the threshold:
determining, by the processor, data rate capabilities for each of the multicast members,
grouping the multicast members into two or more groups based on corresponding data rate capabilities, and
generating a multicast stream for each of the groups at distinct data rates; and
sending, by a network interface of the network device, two or more multicast transmissions downstream to the multicast members groups at the distinct data rates.

2. The method of claim 1, further comprising:
determining an amount of computing resources needed by the network device to facilitate different numbers of unicast transmissions; and
setting the threshold for the number of multicast members based on the determined amount of computing resources needed for the plurality of unicast transmissions.

3. The method of claim 1, further comprising:
prior to detecting the video stream, receiving the video stream from a remote server.

4. The method of claim 1, wherein the multicast members comprise end station devices.

5. The method of claim 1, further comprising:
tracking the number of multicast members;
detecting that the number of multicast members has crossed or will soon cross the threshold; and
dynamically changing between a unicast mode and a data rate grouping mode, responsive to the detection.

6. The method of claim 1, wherein responsive to the number of multicast members meeting or exceeding the threshold:
detecting high priority network packets, including I and P frames from an MPEG format of video multicast; and
automatically retransmitting at least some of the I and P frames.

7. A non-transitory computer-readable medium, storing source code that, when executed by a processor, performs a method in a network device of a data communication network, for increasing delivery probability of multicast video transmissions, the method comprising the steps of:
detecting, by a processor of the network device, a video stream within a multicast transmission of network packets to multicast members;
responsive to a number of multicast members being below a threshold, converting, by the processor, the multicast transmission to a plurality of unicast transmissions, wherein the unicast transmission provides an acknowledgment for received network packets from the multicast members;
responsive to the number of multicast members meeting or exceeding the threshold:
determining, by the processor, data rate capabilities for each of the multicast members,
grouping the multicast members into two or more groups based on corresponding data rate capabilities, and
generating a multicast stream for each of the groups at distinct data rates; and
sending, by a network interface of the network device, two or more multicast transmissions downstream to the multicast members groups at the distinct data rates.

8. The computer-readable medium of claim 7, the method further comprising:
determining an amount of computing resources needed by the network device to facilitate different numbers of unicast transmissions; and
setting the threshold for the number of multicast members based on the determined amount of computing resources needed for the plurality of unicast transmissions.

9. The computer-readable medium of claim 7, the method further comprising:
prior to detecting the video stream, receiving the video stream from a remote server.

10. The computer-readable medium of claim 7, wherein the multicast members comprise end station devices.

11. The computer-readable medium of claim 7, the method further comprising:
tracking the number of multicast members;
detecting that the number of multicast members has crossed or will soon cross the threshold; and
dynamically changing between a unicast mode and a data rate grouping mode, responsive to the detection.

12. The computer-readable medium of claim 7, the method further comprising, wherein responsive to the number of multicast members meeting or exceeding the threshold:
detecting high priority network packets, including I and P frames from an MPEG format of video multicast; and
automatically retransmitting at least some of the I and P frames.

13. A network device of a data communication network, for increasing delivery probability of multicast video transmissions, the network device comprising:
a processor;
a video multicast detection module, communicatively coupled to the processor, the video multicast detection module to detect a video stream within a multicast transmission of network packets to multicast members;
a unicast conversion module, communicatively coupled to the processor and the video multicast detection module, the unicast conversion module 220 to, responsive to a number of multicast members being below a threshold, convert the multicast transmission to a plurality of unicast transmissions, wherein the unicast transmission provides an acknowledgment for received network packets from the multicast members;
a data rate grouping module, communicatively coupled to the processor and the unicast conversion module to, responsive to the number of multicast members meeting or exceeding the threshold:
determine data rate capabilities for each of the multicast members,
group the multicast members into two or more groups based on corresponding data rate capabilities, and
generate a multicast stream for each of the groups at distinct data rates; and
a network interface, communicatively coupled to the network interface and the unicast conversion module and to the data rate grouping module, the network interface to send two or more multicast transmissions downstream to the multicast members groups at the distinct data rates.
